(19) United States
(12) Patent Application Publication
(10) Pub. No.: US 2007/0159300 A1
(43) Pub. Date: Jul. 12, 2007

(54) RFID TAG COMMUNICATION METHOD AND RFID TAG COMMUNICATION DEVICE

(75) Inventor: Fusao Hori, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/560,912

(22) Filed: Nov. 17, 2006

(30) Foreign Application Priority Data
Dec. 28, 2005 (JP) 2005-379832

(51) Int. Cl. H04Q 5/22

(52) U.S. Cl. 340/10.1; 340/572.7

(57) ABSTRACT

An RFID tag communication method in which an RFID tag row composed of the RFID tags arranged in a row is opposed to a transmitting/receiving antenna unit for communicating with the RFID tags, is configured to read IDs from the RFID tags. In the method, the direction in which the transmitting/receiving antenna unit transmits wireless waves is deviated from a maximum-gain direction of the RFID tags, while the RFID tag row remains opposed to the transmitting/receiving antenna unit. The IDs are thereby read from the RFID tags.

### CROSS-REFERENCE TO RELATED APPLICATIONS

This application is based upon and claims the benefit of priority from the prior Japanese Patent Application No. 2005-379832, filed on 28th Dec. 2005, the entire contents of which are incorporated herein by reference.

### BACKGROUND OF THE INVENTION

1. Field of the Invention

The present invention relates to a communication method and a communication device, both configured to read RFID tags. More particularly, the invention relates to an RFID tag communication method and an RFID tag communication device, which can reliably read information from a plurality of RFID tags that are arranged in a row.

2. Description of the Related Art

In recent years, wireless data carriers, which are called “RFID tags,” have come into use. Each RFID tag is assigned with a specific ID and has a memory area in which information can be written and re-written. The ID can be read from the RFID tag by wireless in non-contact fashion. Further, any information can be written in and read from the RFID tag, by wireless in non-contact fashion.

RFID tags, each having a specific ID, are bonded to or incorporated into, for example, mails or packages to send. Thus, these articles that are moved around can be identified. If IDs can be read at a time from many RFID tags attached to such articles, the efficiency of identifying the articles will increase. A method of efficiently reading the IDs from many RFID tags has been proposed (see, for example, Jpn. Pat. Appln. Laid-Open Publication No. 2005-135354). In this method, mails or the like, each having an RFID tag bonded to it, are placed in a special storage box and thus arranged in a row, each oriented in such a direction that the RFID tag may acquire a maximum gain, and the storage box and a transmitting/receiving antenna (RW antenna) are positioned so that the direction in which the RFID tags acquire the maximum gain may become opposite to the direction in which the transmitting/receiving antenna acquires the maximum gain.

The transmitting/receiving antenna receives power from a transmitting/receiving circuit and transmits the power in the form of wireless waves. It is desired that most of the power be transmitted into space. This is because, the larger that part of the power, which is supplied back from the antenna back to the transmitting/receiving circuit, the more the circuit will be adversely influenced. A wireless wave transmitted from the transmitting/receiving antenna reaches each wireless tag. At the RFID tag, the RFID tag is divided into two parts. One part is absorbed by the antenna of the RFID tag, and the other part is reflected by the antenna of the RFID tag. That part of the power which is supplied back to the transmitting/receiving antenna is extremely small, so long as the RFID tag is at an ordinary distance from the transmitting/receiving antenna and is spaced from the wireless tag by an ordinary distance and is positioned in an ordinary manner. The reflected part of the wireless wave can therefore be neglected at the transmitting/receiving antenna.

If the above-described method of reading IDs is employed, however, the RFID tags bonded to the mails placed in the storage box will absorb energy from one another when the IDs are read from the RFID tags at a time. This is inevitable because the mails, which are relatively thin, are densely packed in a row in the storage box. To prevent this energy absorption, the distance between the row of RFID tags and the transmitting/receiving antenna should be shortened. If the distance is shortened, however, a larger part of the wireless wave that has reached the row of RFID tags will be reflected and return to the transmitting/receiving antenna. This is observed as a phenomenon that increases the return loss, in view of the characteristics of the transmitting/receiving antenna. If the wireless-wave energy reflected exceeds the tolerance value to the transmitting/receiving circuit, communication fault or circuit breakdown may occur.

### BRIEF SUMMARY OF THE INVENTION

It is an object of the present invention to provide an RFID tag communication method that can read IDs from many RFID tags arranged in a row at a time.

It is another object of the present invention to provide an RFID tag communication device.

In an aspect of the present invention, there is provided an RFID tag communication method of reading IDs from a plurality of RFID tags, said method including:

a step of opposing an RFID tag row composed of the RFID tags arranged in a row, to a transmitting/receiving antenna for communicating with the RFID tags;

a step of deviating a direction in which the transmitting/receiving antenna transmits wireless waves, from a maximum-gain direction of the RFID tags; and

a step of reading an ID from each of the RFID tags constituting the RFID tag row.

In another aspect of the present invention, there is provided an RFID tag communication device that includes:

a transmitting/receiving antenna;

a holding member for holding a plurality of articles such that the articles, each article having an RFID tag attached, are arranged in a row; and

a transport mechanism for transporting the holding member and the transmitting/receiving antenna relative to each other, and
the holding member deviates a direction in which the transmitting/receiving antenna transmits wireless waves deviate from a maximum-gain direction of the RFID tags, when the holding member is opposed to the transmitting/receiving antenna.

### BRIEF DESCRIPTION OF THE DRAWINGS

FIG. 1 is a schematic diagram of an RFID tag communication system according to an embodiment of the present invention;

FIG. 2 is a diagram schematically illustrating how wireless waves are reflected in the RFID tag communication system of FIG. 1;

FIG. 3 is a diagram schematically showing the structure of a storage box of another type for use in the RFID tag communication system of FIG. 1; and

FIG. 4 is a schematic diagram of an RFID tag communication system according to another embodiment of the present invention.

### DETAILED DESCRIPTION OF THE INVENTION

Throughout this description, the embodiments and examples shown should be considered as exemplars, rather than limitations on the device and methods of the present invention.

Embodiments of the present invention will be described, with reference to the accompanying drawings. A method of reading IDs from the RFID tags attached to, for example, thin mail envelopes, each at a prescribed position on an envelope, will be described. Nevertheless, the present invention is not limited to this.

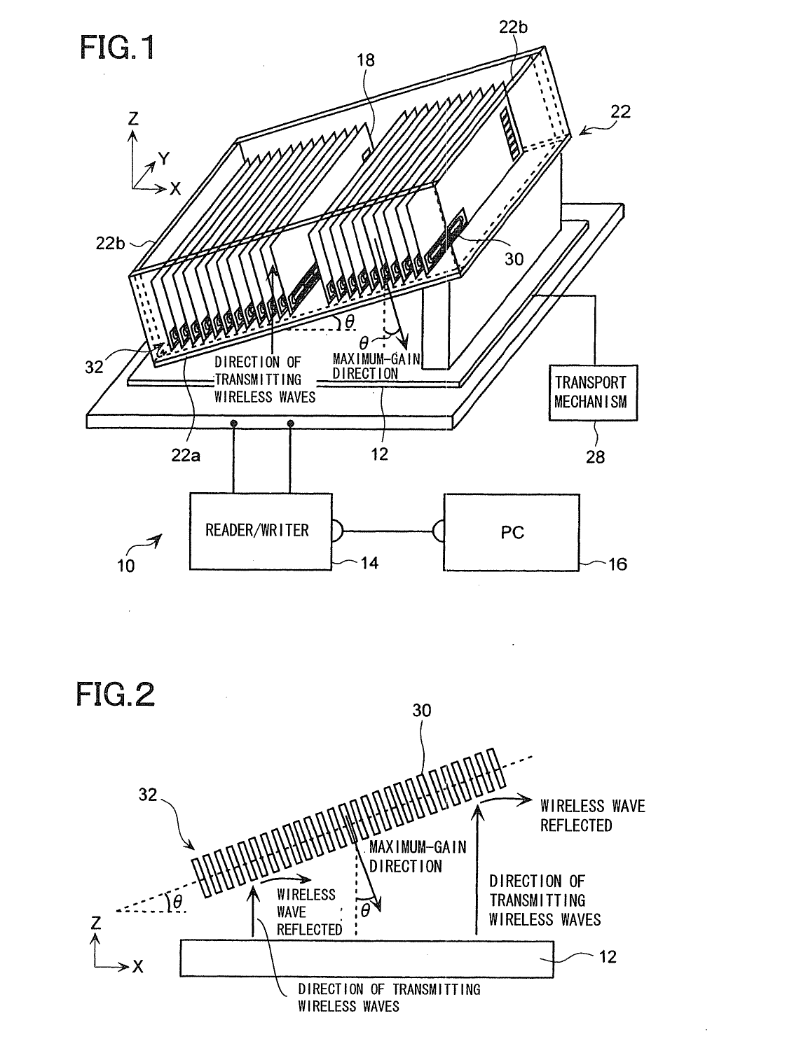

FIG. 1 schematically shows the structure of an RFID tag communication system. The RFID tag communication system comprises an RFID tag communication device 10, a storage box 22, and a transport mechanism 28. The storage box 22 is designed to store envelopes 18, each attached with an RFID tag 30 from which an ID can be read. The transport mechanism 28 is configured to transport the storage box 22.

The envelopes 18 have a length greater than the width. An RFID tag 30 is attached to the lower right-hand corner of each envelope 18. Although its structure is not shown in detail, the RFID tag 30 is one kind of a wireless data carrier. It is an independent article that comprises a tag antenna and an IC chip, which are integrally formed with a substrate. The tag antenna can transmit and receive data. The IC chip incorporates a power-supply unit, a demodulation unit, a modulation unit, a control unit, and a memory. The power-supply unit rectifies and stabilizes the modulated wireless waves received by the tag antenna, thus supplying power to the other components of the IC chip. The demodulation unit demodulates the modulated wireless waves and supplies the resulting wireless waves to the control unit. The modulation unit modulates the data sent from the control unit and supplies the data to the tag antenna. The control unit can write the data demodulated in the demodulation unit, into the memory, can read from the memory the data to be transmitted, and can supply the data thus read, to the modulation unit.

The memory has an ID area and a user area. In the ID area, IDs that the tag manufacturer has assigned to the RFID tags 30 in the process of manufacturing the RFID tags 30. The user can write any data in the user area. In the user area, a tracking-management code is recorded for each envelope 18 to which an RFID tag 30 is attached.

The direction in which the RFID tag 30 acquires a maximum gain is substantially parallel to the major surface of the envelope 18 if the RFID tag 30 is attached to the major surface (i.e., the surface on which the address is written). In other words, the tag antenna of the RFID tag 30 attached to the envelope 18 extends substantially parallel to the major surface of the envelope 18.

The bottom plate 22a of the storage box 22 storing the envelopes 18 is inclined at a specific angle θ to the direction (i.e., X direction) in which the envelopes 18 are arranged. The major surfaces of the two side plates 22b of the storage box 22 space apart in the X direction intersect at angle θ with the vertical direction (i.e., Z direction). The envelopes 18 are therefore placed in the storage box 22, each inclined at angle θ to the vertical direction. In the storage box 22, the RFID tags 30 bonded to many envelopes 18 are arranged at intervals of the envelope thickness, thus forming an RFID tag row.

FIG. 2 schematically illustrates this RFID s tag row as viewed from the side. The RFID tags 30 forming the RFID tag row 32 are arranged in the same direction as the envelopes 18 are arranged. Therefore, the RFID tag row is inclined at angle θ to the X direction. Further, the angle at which each RFID tag 30 extends in the vertical direction to acquire the maximum gain is θ, too, because the direction in which the wireless tag 30 acquires the maximum gain is parallel to the major surface of the envelope 18.

The RFID tag communication device 10 is provided with a transmitting/receiving antenna (RW antenna) unit 12. The antenna unit 12 has a transmitting/receiving antenna (not shown) that can read, in non-contact fashion, the data stored in the memory of any RFID tag 30 that exists in its communication area. The transmitting/receiving antenna of the antenna unit 12 may be a planer patch antenna or a dipole antenna. It transmits wireless waves in a specific direction, in which each RFID tag 30 can acquire the maximum gain is the vertical direction, as shown in FIGS. 1 and 2.

The transmitting/receiving antenna unit 12 is connected to a reader/writer 14. The reader/writer 14 is connected to a higher-order control apparatus such as a personal computer (PC) 16.

The reader/writer 14 comprises a control unit, a modulation unit, a transmission amplifier, a reception amplifier, and a demodulation unit. The control unit is constituted by a CPU, a ROM, a RAM and the like. The CPU controls the communication with the RFID tags 30. The ROM stores an operating program. The RAM temporarily stores data. The modulation unit receives data from the control unit and modulates the data into a modulated signal. The transmission amplifier amplifies the modulated signal, outputting an amplified signal. The amplified signal is transmitted as a wireless wave from the transmitting/receiving antenna unit 12. The reception amplifier amplifies a wireless-wave signal received by the transmitting/receiving antenna unit 12, generating an amplified wireless-wave signal. The demodulation unit demodulates the amplified wireless-wave signal, generating a demodulated wireless-wave signal. The demodulated wireless-wave signal is supplied to the control unit.

In order to achieve communication with the RFID tag row 32, a transmission unit modulates a carrier signal into a power wireless-wave signal. The power wireless-wave signal is transmitted from a transmitting antenna. Thereafter, the transmission unit modulates the data to be transmitted, superimposing the data on the power wireless-wave signal. The signal now superimposed with the data is transmitted from the transmitting antenna.

The transport mechanism 28, which is, for example, a belt conveyor, transports the storage box 22 to a position above the transmitting/receiving antenna unit 12. The transmitting/receiving antenna unit 12 may be configured to access the storage box 22 set at a prescribed position.

The RFID tag communication device 10 has a sensor (not shown). The sensor detects that the storage box 22 storing the envelope 18 is now located above the transmitting/receiving antenna unit 12. After detecting this fact, the RFID tag communication device 10 starts reading the IDs from the RFID tags 30 that constitute the RFID tag row 32.

As described above, the direction in which each of the RFID tags 30 forming the RFID tag row 32 acquires the maximum gain intersects at angle θ to the vertical direction. By contrast, the direction in which the transmitting/receiving antenna unit 12 transmits wireless waves (i.e., maximum-gain direction) is parallel to the vertical direction. Thus, the IDs are read from the RFID tags 30 forming the RFID tag row 32 while the RFID tag row 32 remains opposed to the transmitting/receiving antenna unit 12 such that direction in which the unit 12 transmits wireless waves is inclined at angle θ to the maximum-gain direction of the RFID tags 30.

In such a method of performing communication between the transmitting/receiving antenna unit 12 and each ID, as shown in FIG. 2, any wireless wave reflected by the RFID tag 30 can hardly return to the transmitting/receiving antenna unit 12. Thus, the number of wireless waves returning to the antenna 12 decreases. The power loss due to the reflection of wireless waves therefore decreases, improving the standing wave ratio (SWR). Hence, the circuit breakdown of the reader/writer 14 can be prevented, while maintaining a high accuracy of reading the ID from each RFID tag 30. Moreover, communication faults can be prevented from occurring.

The smaller the angle θ at which the direction in which the transmitting/receiving antenna unit 12 emits WIRELESS waves inclines to the maximum-gain direction of the RFID tags 30, the more wireless waves return to the transmitting/receiving antenna unit 12. It is therefore desired that the angle θ be set to such a value that the power of any reflected wireless wave would not exceed the receiving ability of the transmitting/receiving antenna unit 12. It is further desired that the angle θ be of such a value that the power of any reflected wireless wave would not be applied to the open surface (i.e., the upper surface shown in FIGS. 1 and 2) of the antenna unit 12. If this angle θ is conversely too large, the accuracy of reading the wireless IDs will decrease. That is, the RFID tag 30 at one end of the row 32 is spaced so much from the antenna unit 12 that the accuracy of reading the ID from this tag 30 is low. Therefore, the angle θ should be set to such a value that these undesirable events would not take place.

The angle θ depends on the intervals at which the RFID tags 30 are arranged, forming the RFID tag row 32. When a large number of RFID tags are arranged in a row at constant intervals, forming the RFID tag low. Assume that a communication fault or reading errors occur when the RFID tag row is opposed to the transmitting/receiving antenna unit so that the maximum-gain direction of each RFID tag may identical to the direction in which the transmitting/receiving antenna unit emits wireless waves. In this case, it suffices to set the angle θ to such a value that neither the communication fault nor the reading errors may occur.

Whether the RFID tags are densely arranged or not can be determined in accordance with whether the communication fault or the like develops or the probability of the fault or the like increases when the RFID tag row is opposed to the transmitting/receiving antenna unit so that the maximum-gain direction of each RFID tag may identical to the direction in which the transmitting/receiving antenna unit emits wireless waves. If the communication fault or the like develops, it is determined that the RFID tags are densely arranged. If this is the case, the angle θ is set to a prescribed value.

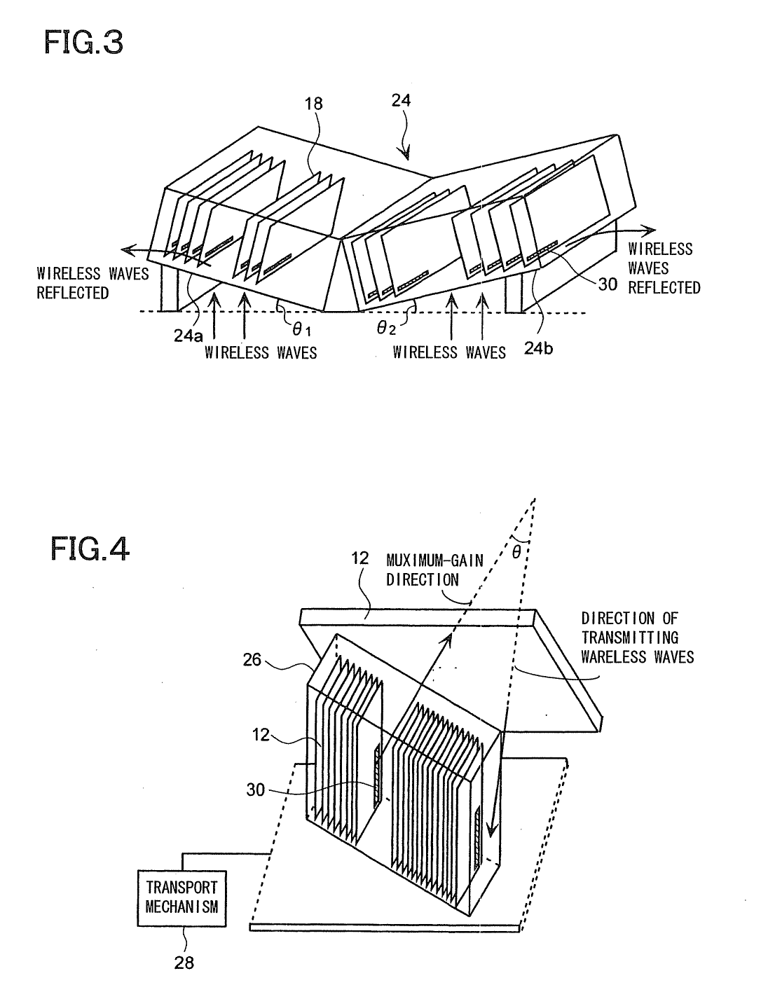

FIG. 3 is a side view schematically shows the structure of a storage box 24 of another type for use in the RFID tag communication system shown in FIG. 1. This storage box 24 is a combination of two boxes identical to the storage box 22 described above. The two boxes have their bottom plates 22a positioned symmetrically with respect to the vertical plane. More specifically, their bottom plates 24a and 24b intersect with the horizontal plane at predetermined angles θ₁ and θ₂, respectively. These angles θ₁ and θ₂ may be either equal or different. The transmitting/receiving antenna unit 12 may emit wireless waves in two or more directions with respect to the maximum-gain direction of the RFID tags 30.

Another embodiment of the present invention will be described next. FIG. 4 shows an RFID tag communication system according to the embodiment. In this communication system, the transmitting/receiving antenna unit 12, that is a patch flat antenna, is vertically positioned so that wireless waves may be emitted in the horizontal direction. The storage box 26 used in this system is designed to hold envelopes 18 (identical to those shown in FIG. 1, having an RFID tag 30 attached at the same position as in the embodiment of FIG. 1). The bottom plate of the storage box 26 extends horizontally. Hence, the RFID tag 30 attached to any envelope 18 stored in the box 26 has a maximum-gain direction that is horizontal.

A transport mechanism 28, such as a belt conveyor, transports the storage box 26 to a position in front of the transmitting/receiving antenna unit 12. The transport mechanism 28 has the function of adjusting the position of the storage box 26 while transporting the box 26 so that the maximum-gain direction of any RFID tag 30 stored in the box 26 may incline at angle θ to the direction in which the unit 12 emits wireless waves. (A turntable, for example, may be rotated to adjust the storage box 26 in position if the box 26 is placed on the turntable. Alternatively, the orientation of the storage box 26 may be changed by pushing the box 26 sideways if the box 26 is transported in one direction by a belt conveyor.) Since an ID is read from each RFID tag 30 while the maximum-gain direction of any RFID tag 30 stored in the box 26 remains inclined at angle θ to the direction in which the unit 12 emits wireless waves, the power of the wireless waves reflected from the RFID tag row formed in the storage box 26 and returning to the transmitting/receiving antenna unit 12 can be reduced.

In the present invention, the wireless waves reflected from the RFID tag row, if any, can be dispersed, making them hardly return to the transmitting/receiving antenna. Hence, the IDs of the RFID tags can be read at a time, without lowering the accuracy of reading these IDs.

The present invention is not limited to the embodiments described above. The components of any embodiment can be modified in various manners in reducing the invention to practice, without departing from the sprit or scope of the invention. Further, the components of any embodiment described above may be combined, if necessary, in various ways to make different inventions. For example, some of the components of any embodiment may not be used. Moreover, the components of the different embodiments may appropriately be combined in any desired fashion.

What is claimed is:

1. An RFID tag communication method of reading IDs from a plurality of RFID tags, comprising:
a step of opposing an RFID tag row composed of the plurality of RFID tags arranged in a row, to a transmitting/receiving antenna for communicating with the RFID tags;
a step of deviating a direction in which the transmitting/receiving antenna transmits wireless waves, from a maximum-gain direction of the RFID tags; and
a step of reading an ID from each of the RFID tags constituting the RFID tag row.

2. The RFID tag communication method according to claim 1, wherein the wireless waves are transmitted from the transmitting/receiving antenna in a plurality of directions that deviate from the maximum-gain direction of the RFID tags.

3. The RFID tag communication method according to claim 1, wherein the direction in which the transmitting/receiving antenna transmits wireless waves is deviated from a maximum-gain direction of the RFID tags, by such an angle that power of any reflected wireless wave does not exceed the maximum power that the transmitting/receiving antenna can receive.

4. The RFID tag communication method according to claim 2, wherein the direction in which the transmitting/receiving antenna transmits wireless waves is deviated from a maximum-gain direction of the RFID tags, by such an angle that power of any reflected wireless wave does not exceed the maximum power that the transmitting/receiving antenna can receive.

5. The RFID tag communication method according to claim 1, wherein the direction in which the transmitting/receiving antenna transmits wireless waves is deviated from a maximum-gain direction of the RFID tags, by such an angle that power of any reflected wireless wave is not applied to an open surface of the transmitting/receiving antenna.

6. The RFID tag communication method according to claim 2, wherein the direction in which the transmitting/receiving antenna transmits wireless waves is deviated from a maximum-gain direction of the RFID tags, by such an angle that power of any reflected wireless wave is not applied to an open surface of the transmitting/receiving antenna.

7. An RFID tag communication device comprising:
a transmitting/receiving antenna for performing communication with RFID tags;
a holding member for holding a plurality of articles having an RFID tag attached such the RFID tag are arranged in a row; and
a transport mechanism for transporting the holding member and the transmitting/receiving antenna relative to each other, thereby opposing the holding member and the transmitting/receiving antenna to each other so that a direction in which the transmitting/receiving antenna transmits wireless waves is deviated from a maximum-gain direction of the RFID tags.

8. An RFID tag communication device comprising:
a transmitting/receiving antenna for performing communication with RFID tags;
a holding member for holding a plurality of articles such that the articles, each article having an RFID tag attached, are arranged in a row; and
a transport mechanism for transporting the holding member and the transmitting/receiving antenna relative to each other,
wherein the holding member is configured to deviate a direction in which the transmitting/receiving antenna transmits wireless waves, from a maximum-gain direction of the wireless tags, when the holding member and the transmitting/receiving antenna are opposed to each other.
